(19) United States
(12) Patent Application Publication
(10) Pub. No.: US 2026/0370059 A1
(43) Pub. Date: Nov. 19, 2026

(54) Wireless Power Transfer System with Power Supply Notification

(71) Applicant: Apple Inc., Cupertino, CA (US)

(72) Inventors: Daniel Ye, La Jolla, CA (US); Jeffrey D. Louis, Chatswood (NZ); Wynand Louis Malan, Auckland (NZ); Zaid A. AbuKhalaf, San Diego, CA (US)

(21) Appl. No.: 19/565,383

(22) Filed: Mar. 12, 2026

Related U.S. Application Data
(60) Provisional application No. 63/807,105, filed on May 16, 2025.

(51) Int. Cl. H02J 50/80; H02J 50/10

(52) U.S. Cl. CPC H02J 50/80; H02J 50/10

(57) ABSTRACT

A wireless charging system may include a wireless power transmitting device that transmits wireless power to a wireless power receiving device. The wireless power transmitting device may be connected to a power supply. The wireless power transmitting device may transmit to the wireless power receiving device an indication of whether the power supply is capable of supplying a maximum load power supported by the wireless power transmitting device.

### CROSS-REFERENCE TO RELATED APPLICATIONS

This application claims the benefit of U.S. provisional patent application No. 63/807,105, filed May 16, 2025, which is hereby incorporated by reference herein in its entirety.

### FIELD

This relates generally to wireless charging systems, and, more particularly, to improvements to wireless charging systems when a wireless power transmitting device in the wireless charging system has a limited power supply.

### Background

In a wireless charging system, a wireless power transmitting device transmits wireless power to a wireless power receiving device. The wireless power receiving device charges a battery and/or powers components using the wireless power. The wireless power transmitting device may receive power from a power supply that is not capable of supplying a level of load power that maximizes wireless charging speeds between the wireless power transmitting and receiving devices.

### Summary

A power receiving device may include a wireless power transfer coil configured to receive wireless power from a power transmitting device, a rectifier connected to the wireless power transfer coil, and control circuitry configured to receive, using the wireless power transfer coil, a data communication packet from the power transmitting device, wherein the data communication packet comprises an indication of whether a power supply for the power transmitting device is capable of supplying a load power supported by the power transmitting device, and select an operating characteristic for wireless power transfer from the power transmitting device to the power receiving device based on the indication.

A power receiving device may include a wireless power transfer coil configured to receive wireless power from a power transmitting device, a rectifier connected to the wireless power transfer coil, an output device, and control circuitry configured to receive, using the wireless power transfer coil, a data communication packet from the power transmitting device, wherein the data communication packet comprises an indication of whether a power supply for the power transmitting device is capable of supplying a load power supported by the power transmitting device, and in response to the indication indicating the power supply for the power transmitting device is not capable of supplying the load power supported by the power transmitting device, outputting, using the output device, a notification. The notification may indicate that wireless power transfer is operating below a maximum capability of the power transmitting device.

A power transmitting device may be configured to receive power from a power supply and transmit wireless power to a power receiving device. The power transmitting device may include a wireless power transfer coil configured to transmit wireless power to the power receiving device, an inverter configured to supply alternating-current drive signals to the wireless power transfer coil, and control circuitry configured to transmit, using the wireless power transfer coil, a data communication packet to the power receiving device, wherein the data communication packet comprises an indication of a limited power supply, and negotiate with the power receiving device to select, based on the indication, a power transfer profile for wireless power transfer from the power transmitting device to the power receiving device.

### BRIEF DESCRIPTION OF THE DRAWINGS

FIG. 1 is a schematic diagram of an illustrative wireless power system in accordance with some embodiments.

FIG. 2 is a circuit diagram of wireless power transmitting and receiving circuitry in accordance with some embodiments.

FIG. 3 is a side view of an illustrative wireless power system where a wireless power transmitting device is connected to a power supply in accordance with some embodiments.

FIG. 4 is a flowchart of illustrative communications within a wireless power system in which a power transmitting device indicates to a power receiving device whether a power supply is capable of supplying a load power supported by the power transmitting device in accordance with some embodiments.

FIG. 5 is a diagram of an illustrative packet that includes limited power supply information in accordance with some embodiments.

FIG. 6 is a flowchart of an illustrative method that may be performed by a wireless power transmitting device in accordance with some embodiments.

FIG. 7 is a flowchart of an illustrative method that may be performed by a wireless power receiving device in accordance with some embodiments.

FIG. 8 is a view of an illustrative wireless power receiving device presenting a visual notification regarding a limited power supply in accordance with some embodiments.

### DETAILED DESCRIPTION

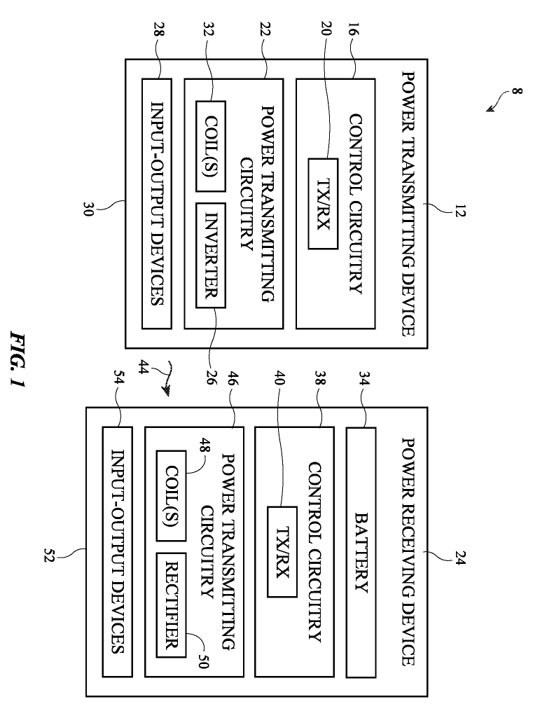

An illustrative wireless power system (also sometimes called a wireless charging system) is shown in FIG. 1. As shown in FIG. 1, wireless power system 8 may include one or more wireless power transmitting devices such as wireless power transmitting device 12 and one or more wireless power receiving devices such as wireless power receiving device 24. Wireless power system 8 may sometimes also be called a wireless power transfer (WPT) system 8 or wireless power system 8. Wireless power transmitting device 12 may sometimes also be called power transmitter (PTX) device 12 or simply PTX 12. Wireless power receiving device 24 may sometimes also be called power receiver (PRX) device 24 or simply PRX 24.

PTX device 12 includes control circuitry 16. Control circuitry 16 is mounted within housing 30. PRX device 24 includes control circuitry 38 mounted within a corresponding housing 52 for PRX device 24. Exemplary control circuitry 16 and control circuitry 38 are used in controlling the operation of WPT system 8. This control circuitry may include processing circuitry that includes one or more processors such as microprocessors, power management units, baseband processors, digital signal processors, microcontrollers, graphics processing units (GPUs), central processing units (CPUs), application processors (APs), application-specific integrated circuits with processing circuits, and/or other processing circuits. The processing circuitry implements desired control and communications features in PTX device 12 and PRX device 24. For example, the processing circuitry may be used in controlling power to one or more coils, determining and/or setting power transmission levels, generating and/or processing sensor data (e.g., to detect foreign objects and/or external electromagnetic signals or fields), processing user input, handling negotiations between PTX device 12 and PRX device 24, sending and receiving in-band and out-of-band data, making measurements, and/or otherwise controlling the operation of WPT system 8.

Control circuitry in WPT system 8 (e.g., control circuitry 16 and/or 38) is configured to perform operations in WPT system 8 using hardware (e.g., dedicated hardware or circuitry), firmware and/or software. Software code for performing operations in WPT system 8 is stored on non-transitory computer readable storage media (e.g., tangible computer readable storage media) in the control circuitry of WPT system 8. The software code may sometimes be called software, data, program instructions, instructions, or code. The non-transitory computer readable storage media may include non-volatile memory such as non-volatile random-access memory (NVRAM), one or more hard drives (e.g., magnetic drives or solid state drives), one or more removable flash drives or other removable media, or the like. Software stored on the non-transitory computer readable storage media may be executed on the processing circuitry of control circuitry 16 and/or 38.

PTX device 12 may be a stand-alone power adapter (e.g., a wireless charging mat or charging puck that includes power adapter circuitry), may be a wireless charging mat or puck that is connected to a power adapter or other equipment by a cable, may be an electronic device (e.g., a laptop computer, a desktop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses, goggles, or other equipment worn on a user’s head, or other wearable or miniature device, a television, a computer display that does not contain an embedded computer, a gaming device, a navigation device, a wireless internet-connected voice-controlled speaker, a home entertainment device, a remote control device, a gaming controller, a peripheral user input device, a wireless base station or access point, equipment that implements the functionality of two or more of these devices, or other electronic equipment), may be equipment that has been incorporated into furniture, a vehicle, or other system, may be a removable battery case, or may be other wireless power transfer equipment.

PRX device 24 may be an electronic device such as a laptop computer, a desktop computer, a computer monitor containing an embedded computer, a tablet computer, a cellular telephone, a media player, or other handheld or portable electronic device, a smaller device such as a wristwatch device, a pendant device, a headphone or earpiece device, a device embedded in eyeglasses, goggles, or other equipment worn on a user’s head, or other wearable or miniature device, a wireless tracking tag, a television, a computer display that does not contain an embedded computer, a gaming device, a navigation device, a wireless internet-connected voice-controlled speaker, a home entertainment device, a remote control device, a gaming controller, a peripheral user input device, a wireless base station or access point, equipment that implements the functionality of two or more of these devices, or other electronic equipment.

PTX device 12 may be connected to a wall outlet (e.g., an alternating current power source), may be coupled to a wall outlet via an external power adapter, may have a battery for supplying power, and/or may have another source of power. In implementations where PTX device 12 is coupled to a wall outlet via an external power adapter, the adapter may have an alternating-current (AC) to direct current (DC) power converter that converts AC power from a wall outlet or other power source into DC power. If desired, PTX device 12 may include a DC-DC power converter for converting the DC power between different DC voltages. Additionally or alternatively, PTX device 12 may include an AC-DC power converter that generates the DC power from the AC power provided by the wall outlet (e.g., in implementations where PTX device 12 is connected to the wall outlet without an external power adapter). DC power may be used to power control circuitry 16. During operation, a controller in control circuitry 16 uses power transmitting circuitry 22 to transmit wireless power to power receiving circuitry 46 of PRX device 24.

Power transmitting circuitry 22 may have switching circuitry, such as inverter circuitry 26 formed from transistors, that are turned on and off based on control signals provided by control circuitry 16 to create AC current signals through one or more wireless power transmitting coils such as wireless power transmitting coil(s) 32. These coil drive signals cause coil(s) 32 to transmit wireless power. In implementations where coil(s) 32 include multiple coils, the coils may be disposed on a ferromagnetic structure, arranged in a planar coil array, or may be arranged to form a cluster of coils (e.g., two or more coils, 5-10 coils, at least 10 coils, 10-30 coils, fewer than 35 coils, fewer than 25 coils, or other suitable number of coils). In some implementations, PTX device 12 includes only a single coil 32.

As the AC currents pass through one or more coils 32, alternating-current electromagnetic (e.g., magnetic) fields (wireless power transfer signals 44) are produced that are received by one or more corresponding receiver coils such as coil(s) 48 in PRX device 24. In other words, one or more of coils 32 is inductively coupled to one or more of coils 48. PRX device 24 may have a single coil 48, at least two coils 48, at least three coils 48, at least four coils 48, or another suitable number of coils 48. When the alternating-current electromagnetic fields are received by coil(s) 48, corresponding alternating-current currents are induced in coil(s) 48. The AC signals that are used in transmitting wireless power may have any desired frequency (e.g., 100-400 kHz, 1-100 MHz, between 1.7 MHz and 1.8 MHz, less than 2 MHz, between 100 kHz and 2 MHz, 128kHz, 326 kHz, 360 kHz, 6.78 MHz, 13.56 MHz, etc.). Rectifier circuitry such as rectifier circuitry 76, which contains rectifying components such as synchronous rectification transistors arranged in a bridge network, converts received AC signals (received alternating-current signals associated with wireless power transfer signals 44) from one or more coils 48 into DC voltage signals for powering PRX device 24. Wireless power transfer signals 44 are sometimes called wireless power 44, wireless charging signals 44, wireless power signals 44, etc. Coils 32 are sometimes called wireless power transfer coils 32, wireless charging coils 32, or wireless power transmitting coils 32. Coils 48 are sometimes called wireless power transfer coils 48, wireless charging coils 48, or wireless power receiving coils 48.

The DC voltage produced by rectifier circuitry 50 (sometime called rectifier output voltage V_{RECT}) may be used in charging a battery such as battery 34 and may be used in powering other components in PRX device 24 such as control circuitry 38, input-output (I/O) devices 54, etc. PTX device 12 may also include input-output devices such as input-output devices 28. Input-output devices 54 and/or input-output devices 28 may include input devices for gathering user input and/or making environmental measurements and may include output devices for providing a user with output.

As examples, input-output devices 28 and/or input-output devices 54 may include a display (screen) for creating visual output, a speaker for presenting output as audio signals, light-emitting diode status indicator lights and other light-emitting components for emitting light that provides a user with status information and/or other information, haptic devices for generating vibrations and other haptic output, and/or other output devices. Input-output devices 28 and/or input-output devices 54 may also include sensors for gathering input from a user and/or for making measurements of the surroundings of WPT system 8.

The example in FIG. 1 of PRX device 24 including battery 34 is illustrative. More generally, an electronic device may include a power storage device 34. Power storage device 34 may be a battery, or may be, for example, a supercapacitor that stores charge.

PTX device 12 and PRX device 24 may communicate wirelessly using in-band or out-of-band-communications. Implementations using in-band communication may utilize, for example, frequency-shift keying (FSK) and/or amplitude-shift keying (ASK) techniques to communicate in-band data between PTX device 12 and PRX device 24. Wireless power and in-band data transmissions may be conveyed using coils 32 and 48 concurrently. When PTX 12 sends in-band data to PRX 24, wireless transceiver (TX/RX) circuitry 20 may modulate wireless charging signal 44 to impart FSK or ASK communications, and wireless transceiver circuitry 40 may demodulate the wireless charging signal 44 to obtain the data that is being communicated. When PRX 24 sends in-band data to PTX 12, wireless transceiver (TX/RX) circuitry 40 may modulate wireless charging signal 44 to impart FSK or ASK communications, and wireless transceiver circuitry 20 may demodulate the wireless charging signal 44 to obtain the data that is being communicated.

Implementations using out-of-band-communication may utilize, for example, hardware antenna structures and communication protocols such as Bluetooth or NFC to communicate out-of-band data between PTX device 12 and PRX device 24. Power may be conveyed wirelessly between coils 32 and 48 concurrently with the out-of-band data transmissions.

Each one of housing 30 and housing 52 may be formed from plastic, metal, fiber-composite materials such as carbon-fiber materials, wood and other natural materials, glass, other materials, and/or combinations of two or more of these materials.

The example in FIG. 1 of PTX 12 transmitting wireless power and PRX 24 receiving wireless power is merely illustrative. PTX 12 may optionally be capable of receiving wireless power transfer signals using coil(s) 32 and PRX 24 may optionally be capable of transmitting wireless power transfer signals using coil(s) 48. When a device is capable of both transmitting and receiving wireless power transfer signals, the device may include both an inverter and a rectifier.

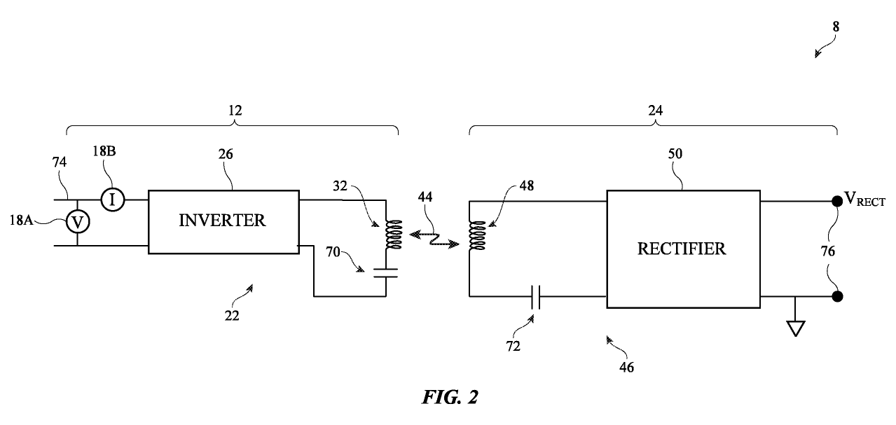

FIG. 2 is a circuit diagram of illustrative wireless charging circuitry for system 8. As shown in FIG. 2, circuitry 22 may include inverter circuitry such as one or more inverters 26 or other drive circuitry that produces wireless power transfer signals that are transmitted through an output circuit that includes one or more coils 32 and capacitors such as capacitor 70. In some embodiments, device 12 may include multiple individually controlled inverters 26, each of which supplies drive signals to a respective coil 32. In other embodiments, an inverter 26 is shared between multiple coils 32 using switching circuitry.

During operation, control signals for inverter(s) 26 are provided by control circuitry 16 at control input(s) 74. A single inverter 26 and single coil 32 is shown in the example of FIG. 2, but multiple inverters 26 and multiple coils 32 may be used, if desired. In a multiple coil configuration, switching circuitry (e.g., multiplexer circuitry) may be used to couple a single inverter 26 to multiple coils 32 and/or each coil 32 may be coupled to a respective inverter 26. During wireless power transmission operations, transistors in one or more selected inverters 26 are driven by AC control signals from control circuitry 16. The relative phase between the inverters may be adjusted dynamically (e.g., a pair of inverters 26 may produce output signals in phase or out of phase).

The application of drive signals using inverter(s) 26 (e.g., transistors or other switches in circuitry 22) causes the output circuits formed from selected coils 32 and capacitors 70 to produce alternating-current electromagnetic fields (signals 44) that are received by wireless power receiving circuitry 46 using a wireless power receiving circuit formed from one or more coils 48 and one or more capacitors 72 in device 24.

Rectifier circuitry 50 is coupled to one or more coils 48 and converts received power from AC to DC and supplies a corresponding direct current output voltage V_{RECT} across rectifier output terminals 76 for powering load circuitry in device 24 (e.g., for charging battery 34, for powering a display and/or other input-output devices 54, and/or for powering other components).

FIG. 2 shows how PTX 12 may include one or more voltage sensors such as voltage sensor 18A and one or more current sensors such as current sensor 18B. The voltage and current sensors within PTX 12 may be used to determine power levels within the system. The specific locations of sensors 18A and 18B (e.g., on the DC side of inverter 26) in FIG. 2 are merely illustrative. In general, voltage and current sensors may be positioned at any desired positions within the power transmitting circuitry 22.

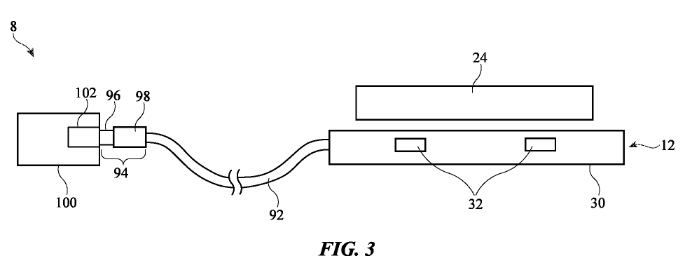

FIG. 3 is a cross-sectional side view of system 8 in an illustrative configuration in which wireless power transmitting device 12 is a wireless charging puck and in which wireless power receiving device 24 is a wristwatch, as an example. As shown in FIG. 3, device 12 has a device housing 30 (e.g., a disk-shaped puck housing formed form polymer, other dielectric material, and/or other materials). Device housing 30 may house a device microcontroller for communicating with plug 94, DC-DC power converter circuitry such as a step-down voltage converter (e.g., a buck converter), voltage regulator circuitry such as a low-dropout (LDO) regulator, wireless power transmitting circuitry such as inverter 26 (see FIG. 2), coil(s) 32, capacitor 70, near-field communications (NFC) circuitry for communicating with power receiving device 24, over-temperature protection (OTP) circuitry such as a temperature sensor, debug circuitry, filter circuitry, magnetic alignment structures such as magnets for attracting device 24 during charging operations, and/or other power transmitting device components.

Cable 92 is coupled to device housing 30 and provides power to coil(s) 32. One end of cable 92 may be pigtailed to housing 30. The opposing end of cable 92 is terminated using plug 94. Plug 94 has a boot portion 98 sometimes called the “boot” of the plug. Cable 92 and plug 94 may be considered part of PTX 12 or may be considered a separate component from PTX 12. Boot 98, which may sometimes be called a connector boot, may be formed from polymer, metal, and/or other materials and may have an interior region configured to house electrical components (e.g., integrated circuits, discrete components such as transistors, printed circuits, etc.). Boot 98 has a first end connected to cable 92 and a second end connected to a connector portion 96 (sometimes called the “connector” of the plug). Connector 96 may include 24 pins, 10-30 pins, 10 or more pins, 20 or more pins, 30 or more pins, 40 or more pins, 50 or more pins, or any suitable number of pins supported within a connector housing. The pins within connector 96 are configured to mate with corresponding pins in port 102 of external equipment such as device 100.

Device 100 may be a stand-alone power adapter that converts alternating-current (AC) power to direct-current (DC) power, an electronic device such as a computer, or other equipment that provides DC power to plug 94 through port 102. Port 102 may be, for example, a universal serial bus (USB) port (e.g., a USB type-C port, a USB 4.0 port, a USB 3.0 port, a USB 2.0 port, a micro-USB port, etc.) or a Lightning connector port. Plug 96 having a connector protruding from boot 98 may be called a male plug. Plug 96 may be a reversible plug (i.e., a plug that may be mated with a corresponding connector port in at least two different and symmetrical orientations). Device 100 supplies DC power used to operate PTX 12. Device 100 may therefore sometimes be called power supply 100 or DC power supply 100.

PTX 12 and device 100 may undergo a power delivery negotiation after PTX 12 is connected to device 100. After PTX 12 is connected to device 100, device 100 may output an initial power level to PTX 12 (using the wired connection between PTX 12 and device 100). PTX 12 and device 100 may subsequently communicate using the wired connection between PTX 12 and device 100 to exchange information about power capabilities. PTX 12 and device 100 may negotiate an increase in the power output from device 100 to a desired level. The communication and negotiation between PTX 12 and device 100 may follow an applicable communication protocol structure (e.g., USB power delivery specifications).

PTX 12 may have a nominal maximum power level that refers to the maximum supported load power for PTX 12. The load power of PTX 12 is the amount of power being delivered to PRX 24 via the inductive link between PTX 12 and PRX 24. For example, a first power transmitting device may have a maximum supported load power of 5 W and therefore may be referred to as a 5 W wireless power transmitting device, a second power transmitting device may have a maximum supported load power of 15 W and therefore may be referred to as a 15 W wireless power transmitting device, a third power transmitting device may have a maximum supported load power of 25 W and therefore may be referred to as a 25 W wireless power transmitting device, etc.

PRX 24 may also have a nominal maximum power level for receiving wireless power from PTX 12. For example, a first power receiving device may be designed to receive wireless power at a power level of less than or equal to 5 W, a second power receiving device may be designed to receive wireless power at a power level of less than or equal to 15 W, a third power receiving device may be designed to receive wireless power at a power level of less than or equal to 25 W, etc.

For a wireless power transmitting device to deliver its maximum supported load power, the wireless power transmitting device must be connected to a power supply that provides power at a sufficiently high magnitude. Take the example of a 15 W wireless power transmitting device (with a maximum supported load power of 15 W). The 15 W wireless power transmitting device may have the arrangement of PTX 12 in FIG. 3. PTX 12 is connected to DC power supply 100 to receive DC power that is used to operate PTX 12.

In a first scenario, the 15 W wireless power transmitting device is connected to a DC power supply 100 that outputs 30 W of power. With this arrangement, the 15 W wireless power transmitting device may operate using a load power of 15 W. In other words, the DC power supply delivers sufficient power for PTX 12 to operate using the maximum supported load power.

In a second scenario, the 15 W wireless power transmitting device is connected to a DC power supply 100 that outputs 5 W of power. With this arrangement, the DC power supply does not deliver enough power for PTX 12 to operate using the maximum supported load power. Even though the 15 W wireless power transmitting device is rated to have a maximum load power of 15 W, the actual load power is limited by the power supply.

To account for power loss through PTX 12, the amount of power output by power supply 100 may need to be higher than the PTX’s maximum supported load power (e.g., by at least 10%, by at least 20%, by at least 30%, by at least 40%, by at least 50%, etc.) to allow PTX 12 to sustain wireless power transmission at the maximum supported load power. The magnitude of excess power above the maximum supported load power, which may be referred to as headroom, needed to sustain wireless power transmission at the maximum supported load power may depend on the efficiency of one or more components within PTX 12 (e.g., boot 98, inverter 26, etc.). There may therefore be scenarios in which the power output by power supply 100 is greater than PTX 12’s maximum supported load power but still insufficient for PTX 12 to sustain wireless power transmission at the maximum supported load power. For example, a power supply that outputs 11 W may be insufficient for a 10 W PTX to sustain power transfer at 10 W if the PTX and PRX system transfers power at less than 90% efficiency.

Scenarios where a PTX is connected to a power supply that does not provide enough power to allow operation at a supported load power are called limited power supply (LPS) scenarios. Limited power supply scenarios may result in negative user experiences such as device charging taking longer than expected. It therefore may be desirable to provide a notification to the user using PTX 12 and/or PRX 24 when a limited power supply scenario is detected.

PTX 12 may determine that power supply 100 is limited when it is plugged into power supply 100. Subsequently, when PRX 24 is coupled with PTX 12 to commence wireless charging operations, PTX 12 may inform PRX 24 of the limited power supply during a negotiation phase. PRX 24 may output a notification regarding the limited power supply based on information received from PTX 12. Instead or in addition to outputting the notification, PRX 24 may select an operating characteristic for wireless power transfer from the power transmitting device to the power receiving device based on information received from PTX 12 regarding the limited power supply.

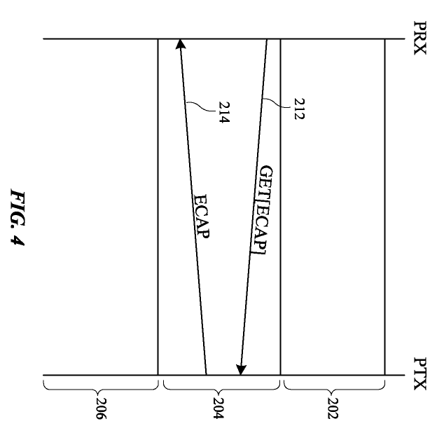

FIG. 4 is a flowchart showing illustrative communications in a wireless charging system where PTX 12 transmits limited power supply information to PRX 24. When PRX 24 is placed on PTX 12, PTX 12 determines that there is a wireless power receiving device present and initiates a digital ping to solicit a response from the wireless power receiving device, as shown by digital ping phase 202 of FIG. 4. Data packets that are transmitted between PTX 12 and PRX 24 may follow an applicable communication protocol structure. Implementations that support the Qi wireless power transfer standard may follow protocol definitions that are promulgated by the Wireless Power Consortium for Qi wireless power transfer.

During digital ping phase 202, inverter 26 is turned on to transmit low-level wireless power signals to PRX 24 using coil 32. PRX 24 may use the wireless power received from the digital ping to send one or more response packets to PTX 12 and proceed with configuration and negotiation operations. The packets transmitted by PRX 24 to PTX 12 during the digital ping phase may include a signal strength (SIG) packet, an identification (ID) packet, an extended identification packet (XID), and/or a configuration (CFG) packet. If the digital ping performed by PTX 12 does not produce a response from a compatible PRX 24, PTX 12 may forego further wireless power transfer and will not commence a wireless power transfer session.

After the digital ping phase is complete, communications between PTX 12 and PRX 24 may proceed to negotiation phase 204. During the negotiation phase, PTX 12 and PRX 24 negotiate characteristics of the wireless power transfer operations such as reference power, FSK polarity and modulation depth, number of cycles per FSK bit, a power level for the wireless power signals transmitted by PTX 12 to PRX 24, a power control profile for the wireless power transfer session, and/or other wireless power transfer and/or communication parameters.

After the negotiation phase is complete, PTX 12 and PRX 24 may begin a wireless power transfer session (as shown by power transfer phase 206). The wireless power transfer session may include sustained transmission of wireless power at a negotiated power level and/or frequency (or a default power level and/or frequency).

PTX 12 may provide power supply information (e.g., whether or not there is a limited power supply) to PRX 24 at any time during the digital ping phase, negotiation phase, or power transfer phase. As one example, PTX 12 may provide the power supply information to PRX 24 during the negotiation phase. As shown in FIG. 4, PRX 24 may transmit a packet 212 (e.g., a GET packet) to PTX 12 requesting a capabilities (e.g., extended power transmitter extended capabilities, or ECAP) packet from PTX 12. Packet 212 may sometimes be called a GET[ECAP] packet. In response to receiving the GET[ECAP] packet, PTX 12 may transmit a packet 214 to PRX 24. Packet 214 may be an extended power transmitter extended capabilities (ECAP) packet (sometimes referred to as an extended capabilities packet) that provides information about the capabilities of the power transmitting device. Extended capabilities packet 214 may include power supply information (e.g., whether or not there is a limited power supply).

Each data packet communicated between PTX 12 and PRX 24 (e.g., packets 212 and 214) may include numerous data bits (sometimes referred to as bits). The data bits may be grouped into bytes, with each byte including any desired number of bits (e.g., 8 bits).

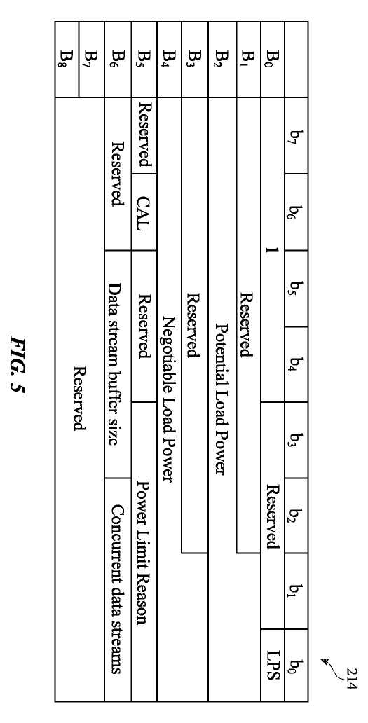

FIG. 5 shows an example packet structure for packet 214 that includes power supply information. As shown, packet 214 includes bytes B₀-B₈ with each byte including 8 bits b₀-b₇. The packet includes one or more bits (e.g., in bytes B₁ and B₂) that represent the potential load power for PTX 12. The potential load power is the rated maximum supported load power for PTX 12. The packet also includes one or more bits (e.g., in bytes B₃ and B₄) that represent the negotiable load power for PTX 12. The negotiable load power is the maximum currently available load power for PTX 12 based on the current operating conditions of the wireless power transfer system. In ideal conditions, the negotiable load power is equal to potential load power. However, in some circumstances the negotiable load power may be less than the potential load power.

Packet 214 also includes one or more bits (e.g., in byte B₅) that represent a power limit reason. The one or more bits may convey a code that is associated with a respective power limit reason. For example, the code for the power limit reason bits may be 0 when the negotiable load power is equal to potential load power (and power is not limited). The code for the power limit reason bits may be non-zero (e.g., a code between 1 and 15) when the negotiable load power is less than the potential load power (and power is therefore limited). Each non-zero code may have an assigned reason for the power limit (e.g., foreign object presence, brown-out protection, over-temperature, maximum inverter voltage reached, over current, maximum available power, etc.).

Packet 214 may also include one or more bits (e.g., CAL at byte B₅ and bit b₆) that identify whether or not a power loss calibration protocol (which may be used for foreign object detection) is supported, one or more bits (e.g., at byte B₆ and bits b₅-b₃) that represent the size of a data stream buffer, and one or more bits (e.g., at byte B₆ and bits b₂-b₀) that represent the maximum number of concurrent data streams the power transmitter can handle.

Packet 214 may include a bit (sometimes called the limited power supply bit or LPS bit) that includes power supply information. In FIG. 5 the limited power supply bit is at byte B₀ and bit b₀. This example is merely illustrative. In general, the limited power supply bit may be at any desired bit location within the packet (e.g., any of the reserved bit locations in FIG. 5). The LPS bit may have a first value (e.g., 0) when the power supply for the power transmitting device is capable of supplying the maximum supported load power for the power transmitting device. The LPS bit may have a second value (e.g., 1) when the power supply for the power transmitting device is not capable of supplying the maximum supported load power for the power transmitting device.

As previously noted, maximum available power is a possible power limit reason that may be identified in packet 214. However, there may be multiple factors (e.g., temperature, foreign object, and limited power supply) influencing the power limit and only one factor is identified by the power limit reason. If the LPS bit was omitted, the PTX 12 may not be able to identify the limited power supply in packet 214 even when the limited power supply is known to PTX 12 (e.g., because another power limit reason such as temperature is identified in the power limit reason field of packet 214). By including the LPS bit in packet 214, PTX 12 ensures that PRX 24 is informed when there is a limited power supply.

During negotiation phase 204, PTX 12 and PRX 24 may negotiate a power mode (sometimes called a power transfer profile) for wireless power transfer from PTX 12 to PRX 24. Each power mode may include a different set of specifications that define how power is transferred between PTX 12 and PRX 24. The different power modes may ramp up power levels at different rates, have different maximum power transfer levels, etc. The different power modes may have different target output characteristics (e.g., frequency, power level, etc.) for coil 32 in PTX 12. As one example, there may be three different power modes associated with PTX 12 and PRX 24. A first power mode (sometimes referred to as a low power mode) may have a first maximum power level (e.g., 5 W). A second power mode (sometimes referred to as a medium power mode) may have a second maximum power level (e.g., 15 W) that is greater than the first maximum power level. A third power mode (sometimes referred to as a high power mode) may have a third maximum power level (e.g., 25 W) that is greater than the second maximum power level.

Some electronic devices may support only one of these power modes. Some electronic devices may support all of these power modes. Some electronic devices may support some but not all of these power modes. When PTX 12 and PRX 24 do support multiple power modes, PTX 12 and/or PRX 24 may select which power mode to use during a wireless power transfer session based at least partially on power supply information. Generally, higher power transfer speeds are preferred, when there is sufficient power supply power.

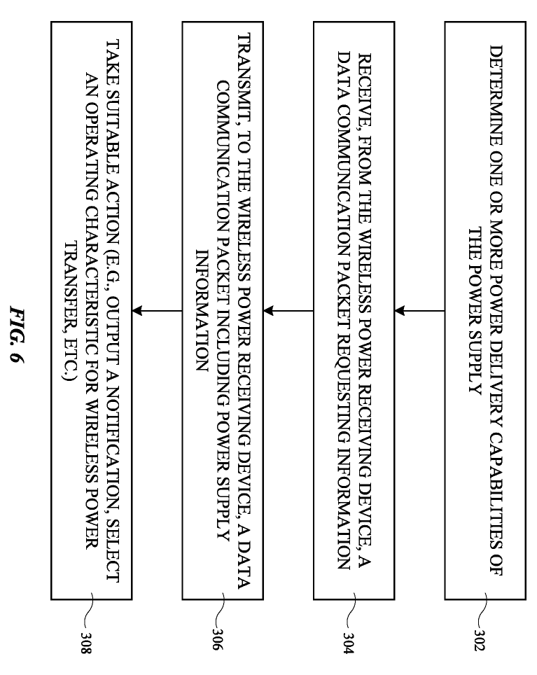

FIG. 6 is a flowchart of an illustrative method that may be performed by PTX 12 (e.g., control circuitry 16 in PTX 12). During the operations of block 302, control circuitry 16 may determine one or more power delivery capabilities (e.g., maximum output current, voltage, and/or power) of power supply 100. In some circumstances, power supply 100 may communicate power supply information directly to PTX 12. For example, power supply 100 may be a USB AC-DC power converter and control circuitry 16 may communicate with the USB AC-DC power converter to determine one or more power delivery capabilities of the USB AC-DC power converter. Power supply 100 may report voltage and current limits to PTX 12 which PTX 12 subsequently uses to derive the maximum power provided by power supply 100. Instead or in addition, power supply 100 may report its power output directly to PTX 12. Instead or in addition, power supply 100 may report device identification information and PTX 12 may determine the power supply’s power output based on the device identification information. The device identification information may be reported from power supply 100 to PTX 12 using digital communication. Alternatively, the device identification information may be determined by applying a particular voltage to a communication port connected between power supply 100 and PTX 12 and measuring the voltage response. The measured voltage response may provide resistance information that is used to determine device identification information for power supply 100. If power supply 100 does not communicate power supply information to PTX 12, PTX 12 may determine the maximum power provided by power supply 100 using one or more voltage sensors (e.g., voltage sensor 18A in FIG. 2) and one or more current sensors (e.g., current sensor 18B in FIG. 2) based on power delivery characteristics of the power supply, such as when the power supply levels off its voltage and/or current supply.

During the operations of block 302, PTX 12 may determine whether power supply 100 is capable of supplying a supported load power for PTX 12 (e.g., the maximum supported load power). If power supply 100 is not capable of supplying the supported load power for PTX 12, the power supply may be considered a limited power supply. PTX 12 may have information stored regarding the power output required from power supply 100 to supply the maximum supported load power for PTX 12. For example, PTX 12 may have stored information indicating that 7 W is required from power supply 100 to inductively supply a 5 W load power, 20 W is required from power supply 100 to inductively supply a 15 W load power, etc. The aforementioned values are merely illustrative and may depend on the efficiency of one or more components within PTX 12.

During the operations of block 304, PTX 12 may receive a packet from PRX 24 requesting information such as capabilities information. The packet received during the operations of block 304 may be the GET[ECAP] packet 212. Packet 212 may be received using in-band communication (e.g., using ASK demodulation) or using out-of-band communication.

During the operations of block 306, PTX 12 may transmit a packet to PRX 24 including power supply information. The packet transmitted during the operations of block 306 may be the extended power transmitter extended capabilities (ECAP) packet 214. The packet transmitted during the operations of block 306 may include one or more bits that identify whether power supply 100 is capable of supplying a supported load power for PTX 12. In particular, the packet may have a bit that has a first value (e.g., 0) when power supply 100 is capable of supplying the maximum supported load power for PTX 12 and a second value (e.g., 1) when power supply 100 is not capable of supplying the maximum supported load power for PTX 12. Packet 214 may be transmitted using in-band communication (e.g., using FSK modulation) or using out-of-band communication.

The operations of block 302 may be performed in response to PTX 12 being connected to a power supply. Alternatively, PTX 12 may perform the operations of block 302 in response to one or more requests from PRX 24. As an example, PTX 12 may receive a power level request from PRX 24. The power level request from PRX 24 may be a part of the GET[ECAP] packet or part of another data communication packet. The power level request may be a request for a specific magnitude of power delivery and/or may be a selection of protocol and/or power mode that has an associated maximum power delivery level. In response to receiving the request(s), PTX 12 may determine one or more target power delivery capabilities for the power supply (e.g., in order to satisfy the one or more requests from PRX 24). PTX 12 may also determine one or more actual power delivery capabilities for the power supply (e.g., using any of the techniques described in connection with the operations of block 302). PTX 12 may then populate the LPS bit in packet 214 based on the one or more target power delivery capabilities for the power supply and the one or more actual power delivery capabilities for the power supply. As an example, the LPS bit may have a first value (e.g., 0, representing false) when the one or more actual power delivery capabilities for the power supply equal or exceed the one or more target power delivery capabilities for the power supply. The LPS bit may have a second value (e.g., 1, representing true) when the one or more actual power delivery capabilities for the power supply are less than the one or more target power delivery capabilities for the power supply.

After the operations of block 306, PTX 12 may optionally take additional suitable action(s) during the operations of block 308. As one example, PTX 12 may negotiate with the power receiving device to select, based on the power supply information, a power mode for wireless power transfer from the power transmitting device to the power receiving device. PTX 12 may transmit and/or receive a data communication packet that indicates the selected power mode. For example, when PTX 12 transmits a packet at block 306 that indicates power supply 100 is capable of supplying the maximum supported load power for PTX 12, PTX 12 and PRX 24 may negotiate to select a first power mode. With all other variables equal, when PTX 12 transmits a packet at block 306 that indicates power supply 100 is not capable of supplying the maximum supported load power for PTX 12, PTX 12 and PRX 24 may negotiate to select a second power mode that is different than the first power mode.

If PTX 12 determines that power supply 100 is not capable of supplying the maximum supported load power for PTX 12, PTX 12 may optionally output a notification during the operations of block 308. PTX 12 may output the notification using any output devices of input-output devices 28. PTX 12 may output a visible notification using a display, a light-emitting diode status indicator light, and/or another light-emitting component. Instead or in addition, PTX 12 may output an audio notification using a speaker and/or may output a haptic notification (e.g., vibrations) using a haptic device. The notification may indicate that wireless power transfer is operating below a maximum capability of the power transmitting device, may indicate that wireless power transfer is operating below a maximum capability of the power receiving device, may indicate that charging speed and/or power is limited by the power supply (e.g., power supply 100), and/or may indicate a slow charging condition. As one specific example, the notification may include the text “slow charger” and/or “slow power supply.”

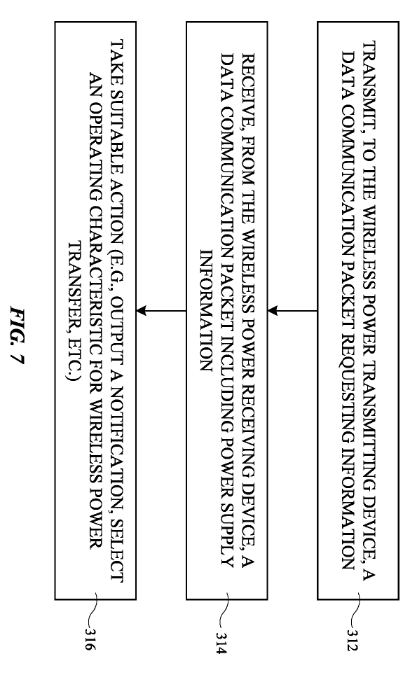

FIG. 7 is a flowchart of an illustrative method that may be performed by PRX 24 (e.g., control circuitry 38 in PRX 24). During the operations of block 312, control circuitry 38 may transmit a packet to PTX 12 requesting information such as capabilities information. The packet transmitted during the operations of block 312 may be the GET[ECAP] packet 212. Packet 212 may be transmitted using in-band communication (e.g., using ASK modulation) or using out-of-band communication.

During the operations of block 314, PRX 24 may receive a packet from PTX 12 including power supply information. The packet received during the operations of block 314 may be the extended power transmitter extended capabilities (ECAP) packet 214. The packet received during the operations of block 314 may include one or more bits that identify whether power supply 100 is capable of supplying a supported load power for PTX 12. In particular, the packet may have a bit that has a first value (e.g., 0) when power supply 100 is capable of supplying the maximum supported load power for PTX 12 and a second value (e.g., 1) when power supply 100 is not capable of supplying the maximum supported load power for PTX 12. Packet 214 may be received using in-band communication (e.g., using FSK demodulation) or using out-of-band communication.

During the operations of block 312, PRX 24 may optionally transmit a data communication packet including a power level request. The power level request(s) may include a request for a specific magnitude of power delivery and/or may be a selection of protocol and/or power mode that has an associated maximum power delivery level. In this example, the LPS bit of packet 214 may have a first value (e.g., 0) when the one or more actual power delivery capabilities for the power supply equal or exceed the one or more target power delivery capabilities for the power supply and may have a second value (e.g., 1) when the one or more actual power delivery capabilities for the power supply are less than the one or more target power delivery capabilities for the power supply (as previously discussed in connection with FIG. 6).

During the operations of block 316, PRX 24 may take suitable action. In particular, PRX 24 may take suitable action based on the one or more bits from packet 214 that identify whether power supply 100 is capable of supplying a supported load power for PTX 12. PRX 24 may select an operating characteristic (e.g., target power level, power mode, etc.) for wireless power transfer from PTX 12 to PRX 24 based on the one or more bits from packet 214 that identify whether power supply 100 is capable of supplying a maximum supported load power for PTX 12. PRX 24 may transmit a data communication packet to PTX 12 indicating the selected operating characteristic.

As a first example, PRX 24 may negotiate with the power transmitting device to select, based on the power supply information, a power mode for wireless power transfer from the power transmitting device to the power receiving device. For example, when PRX 24 receives a packet at block 314 that indicates power supply 100 is capable of supplying the maximum supported load power for PTX 12, PRX 24 may select a first power mode. With all other variables equal, when PRX 24 receives a packet at block 314 that indicates power supply 100 is not capable of supplying the maximum supported load power for PTX 12, PRX 24 may select a second power mode that is different than the first power mode. During the operations of block 316, PRX 24 may transmit a data communication packet to PTX 12 that indicates the selected power mode.

Instead or in addition to selecting an operating characteristic based on the power supply information during the operations of block 316, PRX 24 may output a notification based on the power supply information during the operations of block 316. PRX 24 may output the notification using any output devices of input-output devices 54. PRX 24 may output a visible notification using a display, a light-emitting diode status indicator light, and/or another light-emitting component. Instead or in addition, PRX 24 may output an audio notification using a speaker and/or may output a haptic notification (e.g., vibrations) using a haptic device. The notification may indicate that wireless power transfer is operating below a maximum capability of the power transmitting device and/or the power receiving device. The notification may indicate a slow charging condition, may indicate that wireless charging speed and/or power is limited by the power supply (e.g., power supply 100), and/or may include the text “slow charger” and/or “slow power supply.”

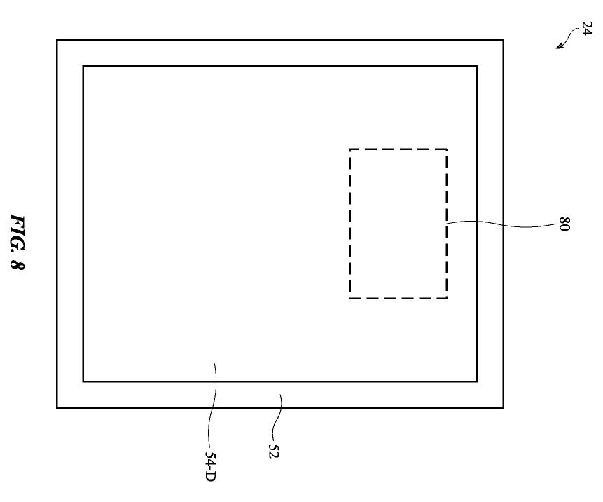

FIG. 8 is a view of a PRX 24 outputting a visible notification. As shown in FIG. 8, display 54-D within housing 52 is visible on the front face of the device. Display 54-D may present a notification 80 that includes text and/or an icon that indicates the power supply for the power transmitting device is not capable of supplying the maximum supported load power for the power transmitting device, wireless power transfer is operating below a maximum capability of the power transmitting device, wireless charging speed and/or power is limited by the power supply, and/or wireless power transfer is operating below a maximum capability of the power receiving device. Instead or in addition, the notification may indicate a slow charging condition and may include the text “slow charger.”

The foregoing is merely illustrative and various modifications can be made to the described embodiments. The foregoing embodiments may be implemented individually or in any combination.

What is claimed is:

1. A power receiving device comprising:
a wireless power transfer coil configured to receive wireless power from a power transmitting device;
a rectifier connected to the wireless power transfer coil; and
control circuitry configured to:
receive, using the wireless power transfer coil, a data communication packet from the power transmitting device, wherein the data communication packet comprises an indication of whether a power supply for the power transmitting device is capable of supplying a load power supported by the power transmitting device; and
select an operating characteristic for wireless power transfer from the power transmitting device to the power receiving device based on the indication.

2. The power receiving device of claim 1, wherein selecting the operating characteristic for the wireless power transfer from the power transmitting device to the power receiving device based on the indication comprises:
selecting a power mode for the wireless power transfer from the power transmitting device to the power receiving device based on the indication; and
transmitting an additional data communication packet to the power transmitting device indicating the selected power mode.

3. The power receiving device of claim 1, wherein the data communication packet comprises:
one or more bits that indicate a rated maximum load power supported by the power transmitting device; and
one or more bits that indicate a maximum load power currently available from the power transmitting device.

4. The power receiving device of claim 1, wherein the data communication packet comprises a capabilities packet that provides information about the capabilities of the power transmitting device.

5. The power receiving device of claim 1, wherein the control circuitry is further configured to:
transmit, using the wireless power transfer coil, a request for the data communication packet to the power transmitting device.

6. The power receiving device of claim 1, wherein the indication is a single bit.

7. A power receiving device comprising:
a wireless power transfer coil configured to receive wireless power from a power transmitting device;
a rectifier connected to the wireless power transfer coil;
an output device; and
control circuitry configured to:
receive, using the wireless power transfer coil, a data communication packet from the power transmitting device, wherein the data communication packet comprises an indication of whether a power supply for the power transmitting device is capable of supplying a load power supported by the power transmitting device; and
in response to the indication indicating the power supply for the power transmitting device is not capable of supplying the load power supported by the power transmitting device, outputting, using the output device, a notification, wherein the notification indicates that wireless power transfer is operating below a maximum capability of the power transmitting device.

8. The power receiving device of claim 7, wherein the data communication packet comprises:
one or more bits that indicate a rated maximum load power supported by the power transmitting device; and
one or more bits that indicate a maximum load power currently available from the power transmitting device.

9. The power receiving device of claim 7, wherein the data communication packet comprises a capabilities packet that provides information about the capabilities of the power transmitting device.

10. The power receiving device of claim 7, wherein the control circuitry is further configured to:
transmit, using the wireless power transfer coil, a request for the data communication packet to the power transmitting device.

11. A power transmitting device configured to receive power from a power supply and transmit wireless power to a power receiving device, the power transmitting device comprising:
a wireless power transfer coil configured to transmit wireless power to the power receiving device;
an inverter configured to supply alternating-current drive signals to the wireless power transfer coil; and
control circuitry configured to:
transmit, using the wireless power transfer coil, a data communication packet to the power receiving device, wherein the data communication packet comprises an indication of a limited power supply; and
negotiate with the power receiving device to select, based on the indication, a power mode for wireless power transfer from the power transmitting device to the power receiving device.

12. The power transmitting device of claim 11, wherein the control circuitry is further configured to:
receive, using the wireless power transfer coil, an additional data communication packet from the power receiving device, wherein the additional data communication packet comprises a power level request.

13. The power transmitting device of claim 12, wherein the control circuitry is further configured to:
based on the power level request, determine one or more target power delivery capabilities for the power supply;
determine one or more actual power delivery capabilities for the power supply; and
populate the indication of the limited power supply based on the one or more target power delivery capabilities and the one or more actual power delivery capabilities.

14. The power transmitting device of claim 11, wherein the control circuitry is further configured to:
determine one or more power delivery capabilities for the power supply; and
populate the indication of the limited power supply based on the one or more power delivery capabilities and a maximum supported load power of the power transmitting device.

15. The power transmitting device of claim 11, wherein the power supply is an AC-DC power converter having a universal serial bus (USB) output and wherein the control circuitry is configured to communicate with the power supply to determine one or more power delivery capabilities of the USB output.

16. The power transmitting device of claim 11, further comprising:
at least one of a voltage sensor and a current sensor, wherein the control circuitry is further configured to use the at least one of the voltage sensor and the current sensor to determine a power delivery capability of the power supply.

17. The power transmitting device of claim 11, wherein the data communication packet comprises:
one or more bits that indicate a rated maximum load power supported by the power transmitting device; and
one or more bits that indicate a maximum load power currently available from the power transmitting device.

18. The power transmitting device of claim 11, wherein the data communication packet comprises a capabilities packet that provides information about the capabilities of the power transmitting device.

19. The power transmitting device of claim 11, wherein the control circuitry is further configured to:
receive, using the wireless power transfer coil, a request for the data communication packet from the power receiving device.

20. The power transmitting device of claim 11, wherein the indication is a single bit.
